(19) United States
(12) Patent Application Publication
(10) Pub. No.: US 2005/0040212 A1
(43) Pub. Date: Feb. 24, 2005

(54) Method for manufacturing nitride light-emitting device

(76) Inventor: Kuang-Neng Yang, Hsinchu Hsien (TW)

Correspondence Address: SUPREME PATENT SERVICES, POST OFFICE BOX 2339, SARATOGA, CA, 95070, US

(21) Appl. No.: 10/646,571

(22) Filed: Aug. 23, 2003

(51) Int. Cl. B23K 31/02

(52) U.S. Cl. 228/254; 228/212

(57) ABSTRACT

A method for manufacturing nitride light-emitting device is disclosed, which fixes two metallic bonding layers together in order to bond a nitride lighting structure grown on a poor thermal conductivity substrate to a high thermal conductivity substrate, then removes the poor thermal conductivity substrate by means of chemical etching, dry etching, or mechanical abrading to thereby transfer the nitride lighting structure onto that high thermal conductivity substrate. Meanwhile, by taking advantage of forming ohmic contact between a transparent conductive layer and an N-type nitride epitaxial layer, the uniformity of current distribution can be significantly improved to thereby suppress light absorption effect and heighten the lighting efficiency of the light emitting device.

### BACKGROUND OF THE INVENTION

1. Field of the Invention

The present invention relates to a method for manufacturing nitride light-emitting device, and particularly to a manufacture method, which is to lay a light-emitting structure of nitride on a high thermal conductivity substrate by transference due to the formation of a bonding layer.

2. The Prior Arts

An aluminum oxide (Al₂O₃) substrate is generally used in a common manufacture method of the prior nitride light-emitting device for growing epitaxy thereon. However, the effective lighting area of epitaxial grains has been lessened because both the P- and the N-type electrodes are inevitably arranged on the same side due to the insulating property of the substrate itself. Because the conductivity of the P-type nitride is far lower than that of the N-type, a translucent metallic conductive layer is adopted to serve for an ohmic contact layer for distributing current uniformly, which reduces light emitting efficiency significantly.

### SUMMARY OF THE INVENTION

Therefore, a method for manufacturing nitride light-emitting device of the present invention by means of chip-bonding technology is disclosed for eliminating the defects in the prior arts. Also, in view of the poor thermal conductivity of the insulating aluminum oxide substrate mentioned in foregoing background, the present invention is to fix two metallic bonding layers together in order to bond a nitride lighting structure grown on a poor thermal conductivity substrate to a high thermal conductivity substrate, then remove the poor thermal conductivity substrate by means of chemical etching, dry etching, or mechanical abrading to thereby transfer the nitride lighting structure onto that high thermal conductivity substrate.

The primary object of the present invention is, on the one hand, to form an epitaxial layer of a nitride lighting structure on a high thermal conductivity substrate and prepare a vertical single lead wire structure, an N-type or P-type electrode for example, to hence lessen the light-shading area. On the other hand, an ohmic contact layer is formed to connect a transparent conductive layer with the N-type nitride epitaxial layer to have current distribution and light emitting efficiency improved significantly.

Another object of the present invention is to provide a method for manufacturing a light emitting device on a high thermal conductivity substrate with reliable stability under a relatively larger working current.

Yet, another object of the present invention is to provide a vertical electrode structure requiring only a single lead wire to therefore save considerable package cost.

For more detailed information regarding advantages or features of the present invention, at least an example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 shows a schematic lighting structure of nitride according to a method for manufacturing nitride light-emitting device of the present invention;

FIG. 2 shows a schematic high thermal conductivity substrate according to the method for manufacturing nitride light-emitting device of the present invention;

FIG. 3 shows a schematic bonding of the high thermal conductivity substrate and the lighting structure of nitride according to the method for manufacturing nitride light-emitting device of the present invention;

FIG. 4 shows that the lighting structure of nitride is transferred onto the high thermal conductivity substrate according to the method for manufacturing nitride light-emitting device of the present invention;

FIG. 5 shows schematically a transparent conductive layer according to the method for manufacturing nitride light-emitting device of the present invention;

FIG. 6 shows schematically an N-type and a P-type electrode according to the method for manufacturing nitride light-emitting device of the present invention; and

FIG. 7 shows a flowchart according to the method for manufacturing nitride light-emitting device of the present invention.

### DETAILED DESCRIPTION OF THE PREFERRED EMBODIMENT

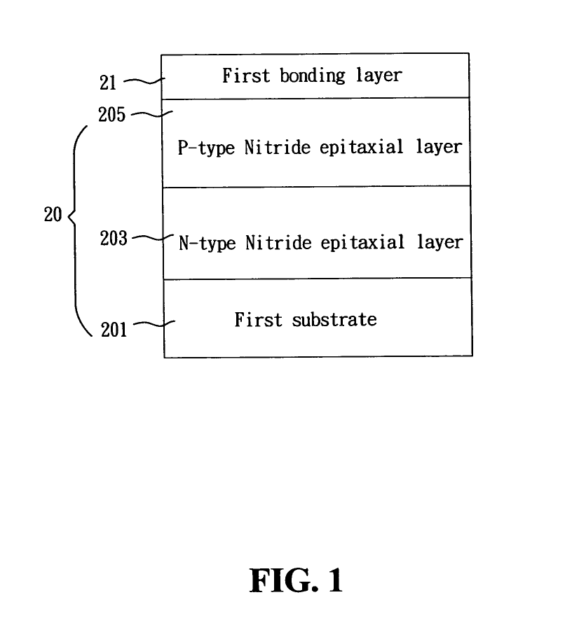

FIG. 1 shows a schematic lighting structure of nitride according to a method for manufacturing nitride light-emitting device of the present invention. As shown in FIG. 1, a lighting structure 20 according to a method for manufacturing nitride light-emitting device of the present invention comprises: a first substrate 201 made of aluminum oxide (Al₂O₃); an N-type nitride epitaxial layer 203, which is an epitaxial structure layer formed on the first substrate 201 by way of currently known epitaxial growth technology; and a P-type nitride epitaxial layer 205, which is also an epitaxial structure layer formed on the N-type nitride epitaxial layer 203 by the same technology growing the N-type nitride epitaxial layer 203.

For a bonding operation to be performed later, a first bonding layer 21 is grown on the P-type nitride epitaxial layer 205 of the nitride lighting structure 20 by depositing, sputtering, electroplating or other known techniques. In this case, depositing is adopted. Indium-tin alloy is a preferred material, and 1 μm is a preferred thickness. Other than the indium-tin alloy, at least any metal chosen from any combination of Al, Ag, Au, Ni, Cu, Pt, Ti, and Pt can be used.

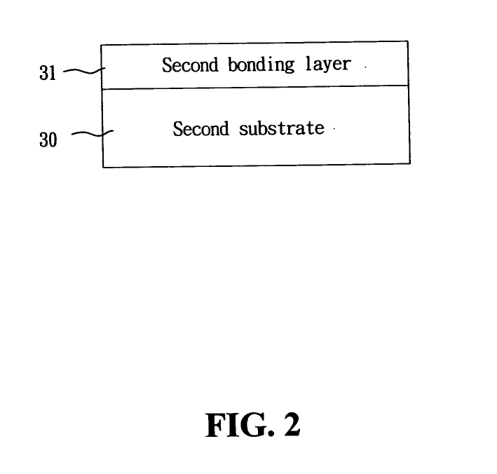

FIG. 2 shows a schematic high thermal conductivity substrate according to the method for manufacturing nitride light-emitting device of the present invention. As shown in FIG. 2, the method of the present invention requires a second high thermal conductivity substrate 30 made of any of semiconductors, metals, and alloys, having a thermal conductive coefficient higher than 150 W/m-K. Aluminum is taken as an example in the embodiment of the present invention.

In order to bond the nitride lighting structure 20, a second bonding layer 31 is formed on the second substrate 30. The material of the second bonding layer 31 is a metal chosen from any combination of Al, Ag, Au, Ni, Cu, Pt, Ti, and Pt formed by depositing, sputtering, electroplating and other known techniques. In the embodiment illustrated, the second bonding layer 31 is made of aluminum by depositing and having a thickness of 1 μm.

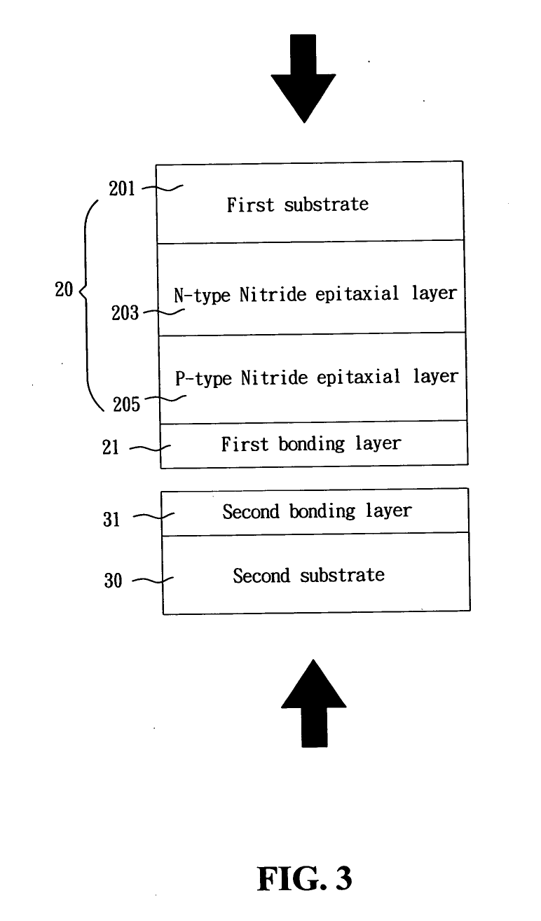

FIG. 3 shows a schematic bonding of the high thermal conductivity substrate and the lighting structure of nitride according to the method for manufacturing nitride light-emitting device of the present invention. The method of the present invention requires bonding the second high thermal conductivity substrate 30 with the nitride lighting structure 20 with the first bonding layer 21 and the second bonding layer 31 fixed together face to face by setting a clamp thereon, and then applying a pressure in the directions indicated by arrows shown in the drawing. The first and second bonding layers 21, 22 are bonded at a temperature of 300° C. with a pressure of 4 kg/cm².

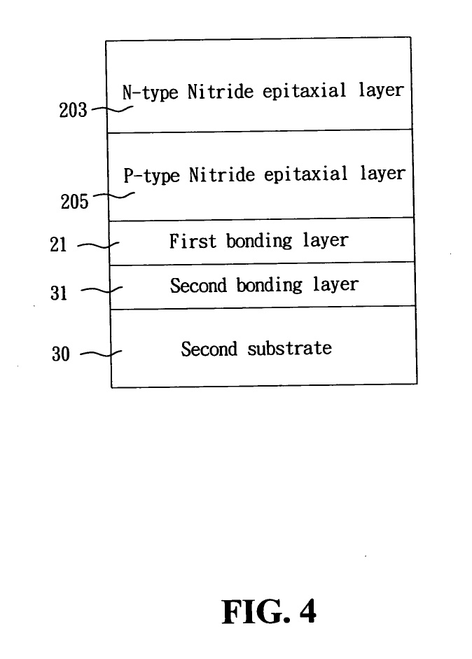

FIG. 4 shows that the lighting structure of nitride is transferred onto the high thermal conductivity substrate according to the method for manufacturing nitride light-emitting device of the present invention. As shown in FIG. 4, the first substrate 201 of the nitride lighting structure 20 is removed to expose the N-type nitride epitaxial layer 203. In removing the first substrate 201, any of a chemical etching, dry etching, and mechanical grinding is applicable and in the embodiment illustrated, the chemical etching is employed.

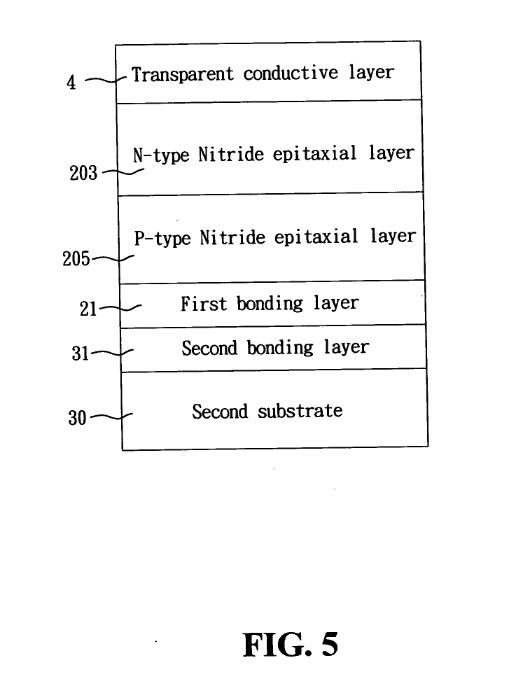

FIG. 5 shows schematically a transparent conductive layer according to the method for manufacturing nitride light-emitting device of the present invention. As shown in FIG. 5, a transparent conductive layer 4 is formed on the N-type nitride epitaxial layer 203 by depositing, sputtering, or plating, and the material of the transparent conductive layer 4 could be any of indium oxide, tin oxide, indium-tin oxide, zinc oxide, indium-zinc oxide, conductive nitride (CN), or magnesium oxide. In the embodiment illustrated, indium oxide is used.

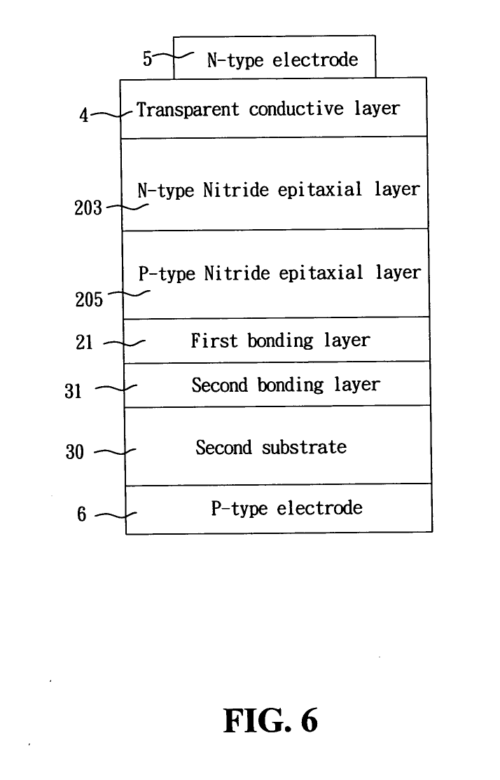

FIG. 6 shows schematically an N-type and a P-type electrode according to the method for manufacturing nitride light-emitting device of the present invention. An N-type electrode 5 and a P-type electrode 6 are formed on the transparent conductive layer 4 and the second high thermal conductivity substrate 30, respectively, by depositing. Other than depositing, sputtering or plating is also possible to form the N-type electrode 5 and the P-type electrode 6.

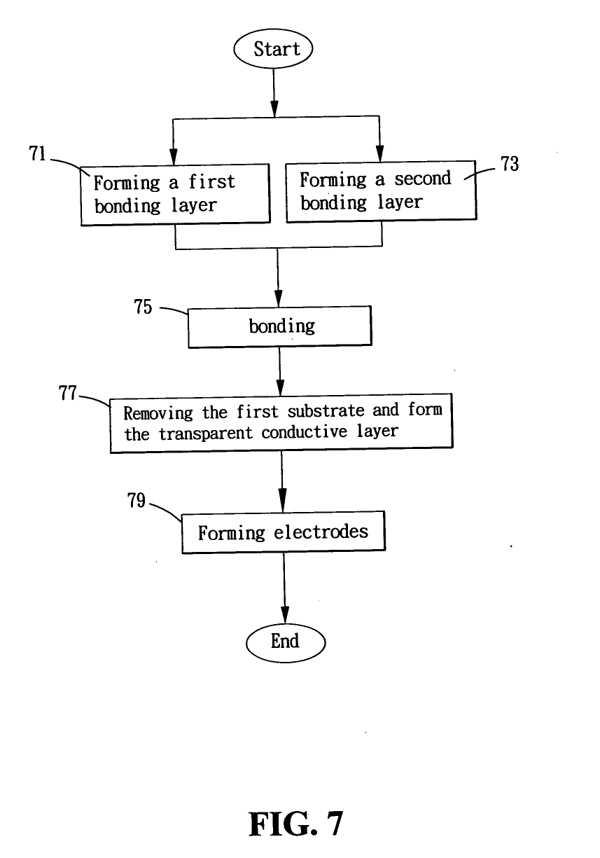

FIG. 7 shows a flowchart according to the method for manufacturing nitride light-emitting device of the present invention. A nitride lighting structure 20 and a second substrate 30 are provided in the method for manufacturing a nitride light-emitting device of the present invention.

For a chip bonding step 75 to be performed later, a step 71 and a step 73 are proceeded at start simultaneously to deposit a first bonding layer 21 and a second bonding layer 31 on a P-type nitride epitaxial layer 205 of a nitride lighting structure 20 and on a second high thermal conductivity substrate 30, respectively.

The bonding step 75 is performed by setting a clamp on the first and second bonding layers 21, 31, and then fixing them together face to face with a predetermined pressure to have the nitride lighting structure 20 transferred and laid on the second high thermal conductivity substrate 30. The bonding operation is performed at a temperature of 300° C. with a pressure of 4 kg/cm².

A next step 77 for forming a transparent conductive layer 4 is to remove a first substrate 201 of the nitride lighting structure 20 to therefore expose an N-type nitride epitaxial layer 203 of the nitride lighting structure 20 and form the transparent conductive layer 4 on that N-type nitride epitaxial layer 203.

A final step 79 for forming electrodes is performed to form a N-type electrode 5 and a P-type electrode 6 on the transparent conductive layer 4 and the second substrate 30, respectively.

In the above described, at least one preferred embodiment has been described in detail with reference to the drawings annexed, and it is apparent that numerous changes or modifications may be made without departing from the true spirit and scope thereof, as set forth in the claims below.

1. A method for manufacturing nitride light-emitting device, comprising the following steps:
providing a nitride lighting structure and a second substrate, the nitride lighting structure further comprising:
a first substrate made of aluminum oxide;
an N-type nitride epitaxial layer formed on the first substrate; and
a P-type nitride epitaxial layer formed on the N-type nitride epitaxial layer;
forming a first bonding layer on the P-type nitride epitaxial layer of the nitride lighting structure;
forming a second bonding layer on the second substrate, which is made of a semiconductor or a metal or an alloy;
fixing the first bonding layer and the second bonding layer together;
removing the first substrate of the nitride lighting structure to expose the N-type nitride epitaxial layer of the nitride lighting structure;
forming a transparent conductive layer on the N-type nitride epitaxial layer;
forming an N-type electrode on the transparent conductive layer; and
forming a P-type electrode on the second substrate.

2. The method according to claim 1, wherein the first bonding layer is made of any of or any combination of aluminum, silver, gold, nickel, copper, platinum, titanium and palladium.

3. The method according to claim 1, wherein the first bonding layer has a thickness of 1 μm.

4. The method according to claim 1, wherein the first bonding layer is formed by depositing or sputtering or plating.

5. The method according to claim 1, wherein the thermal conductivity coefficient of the second substrate is larger than 150 W/m-K.

6. The method according to claim 1, wherein the second substrate is made of aluminum.

7. The method according to claim 1, wherein the second bonding layer is made of any of or any combination of aluminum, silver, gold, nickel, copper, platinum, titanium and palladium.

8. The method according to claim 1, wherein the second bonding layer has a thickness of 1 μm.

9. The method according to claim 1, wherein the second bonding layer is formed by depositing or sputtering or plating.

10. The method according to claim 1, wherein the first bonding layer and the second bonding layer are fixed face to face with a clamp and then bonded.

11. The method according to claim 10, wherein the first bonding layer and the second bonding layer are bonded together at a temperature of 300° C. with a pressure of 4 kg/cm².

12. The method according to claim 1, wherein the first substrate is removed by chemical etching or dry etching or mechanical abrading.

13. The method according to claim 1, wherein the transparent conductive layer is made of any of or any combination of indium oxide, tin oxide, indium-tin oxide, zinc oxide, indium-zinc oxide, conductive nitride and magnesium oxide.
